(19) United States
(12) Patent Application Publication
(10) Pub. No.: US 2022/0111456 A1
(43) Pub. Date: Apr. 14, 2022

(54) ELECTRICAL DISCHARGE MACHINE

(71) Applicant: Sodick Co., Ltd., Kanagawa (JP)

(72) Inventor: Kuniharu YAMADA, Kanagawa (JP)

(73) Assignee: Sodick Co., Ltd., Kanagawa (JP)

(21) Appl. No.: 17/488,332

(22) Filed: Sep. 29, 2021

(30) Foreign Application Priority Data
Oct. 12, 2020 (JP) 2020-171905

(51) Int. Cl. B23H 7/36; G01N 21/55

(52) U.S. Cl. CPC B23H 7/36; G01N 2021/8405; G01N 21/55

(57) ABSTRACT

An electrical discharge machine includes a critical angle detection device that detects a critical angle of a machining fluid in which a corrosion inhibitor is added. The critical angle detection device includes a prism, a light source, an image sensor, an electrical circuit, and a slit. The prism has an incident surface, a boundary surface, a reflection surface, and an emission surface. The light source irradiates an incident light from the incident surface to the boundary surface. The image sensor includes a plurality of photodetectors that detect a reflection light. The electrical circuit calculates the critical angle by arithmetically processing output signals output from the plurality of photodetectors. The slit is arranged on an optical axis of the reflection light between the prism and the image sensor to block a scattered light.

### CROSS-REFERENCE TO RELATED APPLICATION

This application claims the priority benefit of Japan application serial No. 2020-171905, filed on Oct. 12, 2020. The entirety of the above-mentioned patent application is hereby incorporated by reference herein and made a part of this specification.

### BACKGROUND

### Technical Field

The disclosure relates to an electrical discharge machine.

### Related Art

When a workpiece made of an iron-based material, a cemented carbide which is a kind of sintered alloy, or the like is submerged in an aqueous machining fluid and electrical discharge machining is performed, electrical corrosion may occur in the workpiece. It is considered that, for example, when the machining is performed in a wire electrical discharge machine using a wire electrode made of brass and the like as a negative electrode and a workpiece made of an iron-based material, a cemented carbide, or the like as a positive electrode, a corrosion current flows between the negative electrode and the positive electrode because of a potential difference between the negative electrode and the positive electrode, the workpiece as the positive electrode elutes, and electrical corrosion in the workpiece occurs. In addition, a corrosive ion in the aqueous machining fluid may also cause corrosion in the workpiece.

Therefore, conventionally, in order to prevent the corrosion of the workpiece, management is performed in which a corrosion inhibitor is added to the machining fluid, and a concentration of the corrosion inhibitor in the machining fluid is detected and is adjusted within a specified range.

U.S. Pat. No. 10,618,126 B2 discloses a technique in which a change in characteristics associated with a change in color is detected at regular intervals by a detector, by utilizing the color development of a metal complex composed of a rust preventive agent and a coloring reagent. When the concentration of the rust preventive agent is below a certain value, the color of the machining fluid becomes lighter, and when the concentration of the rust preventive agent exceeds the certain value, the color of the machining fluid becomes deeper. Therefore, the optical sensor detects the change in color of the machining fluid, and a command to add the rust preventive agent or the machining fluid is output to a controller.

International Publication No. WO 2009/147856 A1 discloses a technique in which powdered adenine is used as a corrosion inhibitor. When an operator inputs a concentration of the adenine, an adenine addition control mechanism sets the discharge amount of a pump of an adenine addition device to a predetermined value and adjusts the concentration of the adenine in the machining fluid.

### SUMMARY

It is known that the corrosion inhibitor in the machining fluid is effective when the concentration thereof is in a predetermined concentration range, and the rust preventive effect is reduced if the concentration is out of the predetermined concentration range. Therefore, the management is important in which the concentration of the corrosion inhibitor in the machining fluid is detected in real time and is adjusted within an appropriate range. The concentration of the corrosion inhibitor in the fluid can be detected by various methods; for example, a light-based detection method such as a transmission densitometer or a reflection densitometer is used. However, in this concentration detection method, installation errors during assembly, detection errors due to aging deterioration of the instrument, dirt on the instrument and the like, and changes in the external environment such as changes in the temperature of the machining fluid cause variations in the measurement value, thus making it difficult to detect an accurate concentration.

As a measure to solve the above problems, in the prior art disclosed in US Patent Publication No. 10,618,126 B2, an attempt has been made in which a coloring reagent, a fluorescent reagent, or the like is added to facilitate detection of a measurement light. However, because it is necessary to add a reagent, the work becomes complicated, and because it is necessary to purchase the reagent additionally, the cost for detecting the concentration is increased.

The disclosure provides an electrical discharge machine capable of accurately and quickly detecting the concentration of the corrosion inhibitor in the machining fluid, and capable of appropriately managing the concentration of the corrosion inhibitor within a specified range even when the measurement light is reduced by external factors such as a temperature change of the machining fluid.

According to the disclosure, an electrical discharge machine is provided, which includes a critical angle detection device that detects a critical angle of a machining fluid in which a corrosion inhibitor is added. The critical angle detection device includes: a prism having an incident surface, a boundary surface, a reflection surface, and an emission surface; a light source that irradiates an incident light from the incident surface to the boundary surface which is a boundary between the prism and the machining fluid; an image sensor including a plurality of photodetectors that detect a reflection light reflected from the boundary surface and the reflection surface; an electrical circuit that calculates the critical angle by arithmetically processing output signals output from the plurality of photodetectors; and a slit that is arranged on an optical axis of the reflection light between the prism and the image sensor to block a scattered light.

According to the disclosure, because the critical angle detection device that detects the critical angle of the machining fluid is arranged, and the measurement is performed in a state where a scattered light is appropriately removed by the slit installed inside the critical angle detection device, the concentration of the corrosion inhibitor in the machining fluid can be detected more accurately.

### BRIEF DESCRIPTION OF THE DRAWINGS

FIG. 1 is a schematic view showing an appearance of an electrical discharge machine 100 according to an embodiment of the disclosure.

FIG. 2 is a rear side perspective view showing an appearance of a machining fluid supply device 40 according to the embodiment.

FIG. 3 is a system diagram showing a device configuration of the machining fluid supply device 40 according to the embodiment.

FIG. 4 is a schematic view showing a configuration of an addition device 44 according to the embodiment.

FIG. 5 is an enlarged view of A shown in FIG. 2.

FIG. 6 is a schematic view showing an internal configuration of a critical angle detection device 45 according to the embodiment.

FIG. 7 is an enlarged view of B shown in FIG. 6.

FIG. 8 is an illustration view for illustrating an incident light R1 and a reflection light R2 of the critical angle detection device 45 according to the embodiment.

FIG. 9 is a schematic view showing a slit 458 of the critical angle detection device 45 according to the embodiment.

FIG. 10 is a block diagram showing a configuration of the machining fluid supply device 40 according to the embodiment.

FIG. 11 is an illustration diagram showing a critical angle detection process of a critical angle detection circuit 456ea according to the embodiment.

FIG. 12 is a graph showing a relationship between positions of photodetectors of an image sensor 459 and output voltages of the respective photodetectors.

### DESCRIPTION OF THE EMBODIMENTS

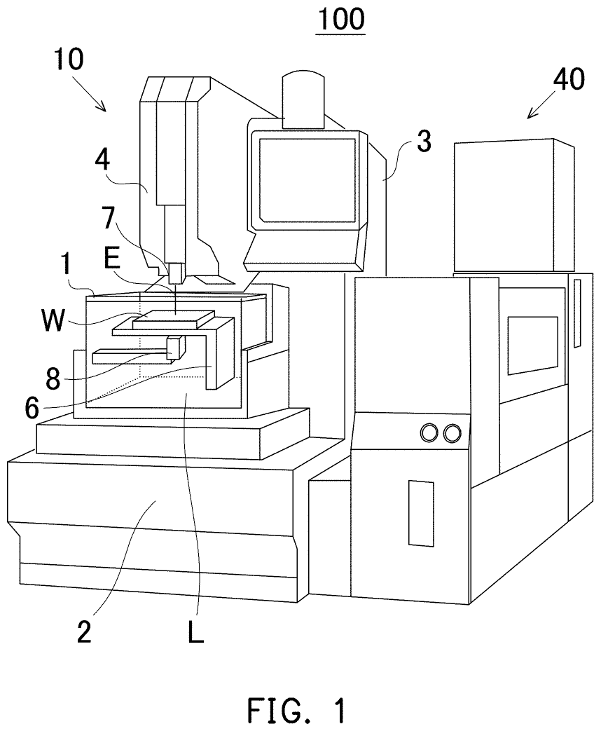

An embodiment of the disclosure is described below in detail with reference to drawings. An electrical discharge machine 100 according to the embodiment is a wire electrical discharge machine that uses a wire electrode E as a tool electrode, but the electrical discharge machine may be a sinker electrical discharge machine that uses a formed electrode as a tool electrode, or may be a small hole electrical discharge machine that uses a rod-shaped electrode or a pipe electrode as a tool electrode. FIG. 1 is a schematic view showing an appearance of the electrical discharge machine 100 according to the embodiment of the disclosure. The electrical discharge machine 100 includes a machine body 10 and a machining fluid supply device 40 which is arranged adjacent to the machine body 10.

The machine body 10 is an apparatus that generates an electrical discharge between electrode gaps formed between the wire electrode E and a workpiece W to perform electrical discharge machining. The machine body 10 includes a base 2, a column 3 erected from a rear part of the base 2, a machining head 4 mounted on an upper front part of the column 3, a machining tank 1 placed on a front part of the base 2, and a workpiece table 6 which is accommodated in the machining tank 1 and holds the workpiece W. An upper guide assembly 7 is arranged on the machining head 4, a lower guide assembly 8 is arranged on a lower front part of the column 3, and the upper guide assembly 7 and the lower guide assembly 8 are arranged across the workpiece W. The upper guide assembly 7 and the lower guide assembly 8 respectively have an upper guide and a lower guide for guiding the wire electrode E. The wire electrode E as a tool electrode is continuously supplied between the upper guide assembly 7 and the lower guide assembly 8. The workpiece W is submerged in an aqueous machining fluid L (hereinafter, simply referred to as the machining fluid L) in the machining tank 1. A voltage is applied between the electrode gaps formed between the wire electrode E and the workpiece W, the electrical discharge is generated, and the electrical discharge machining is performed.

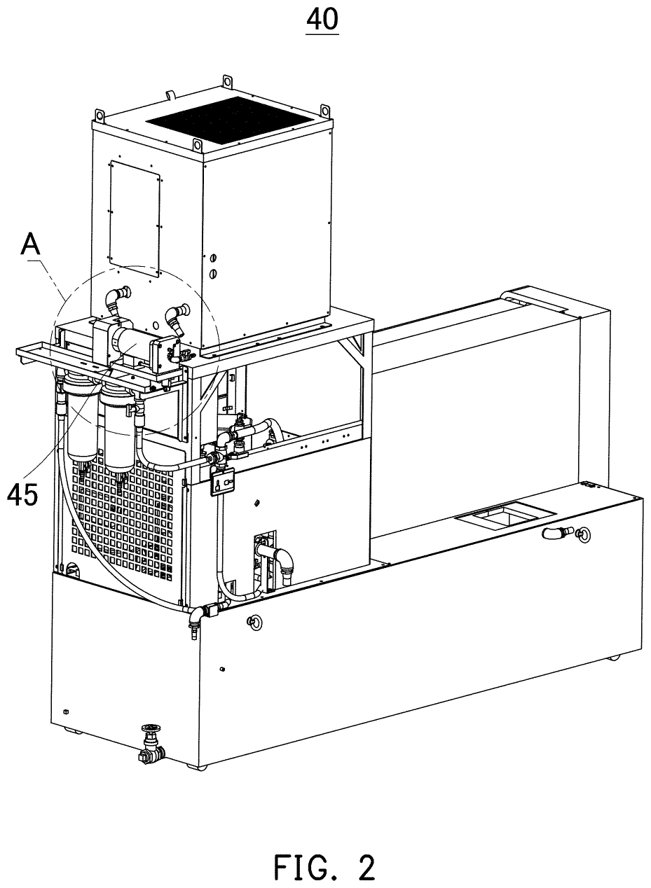

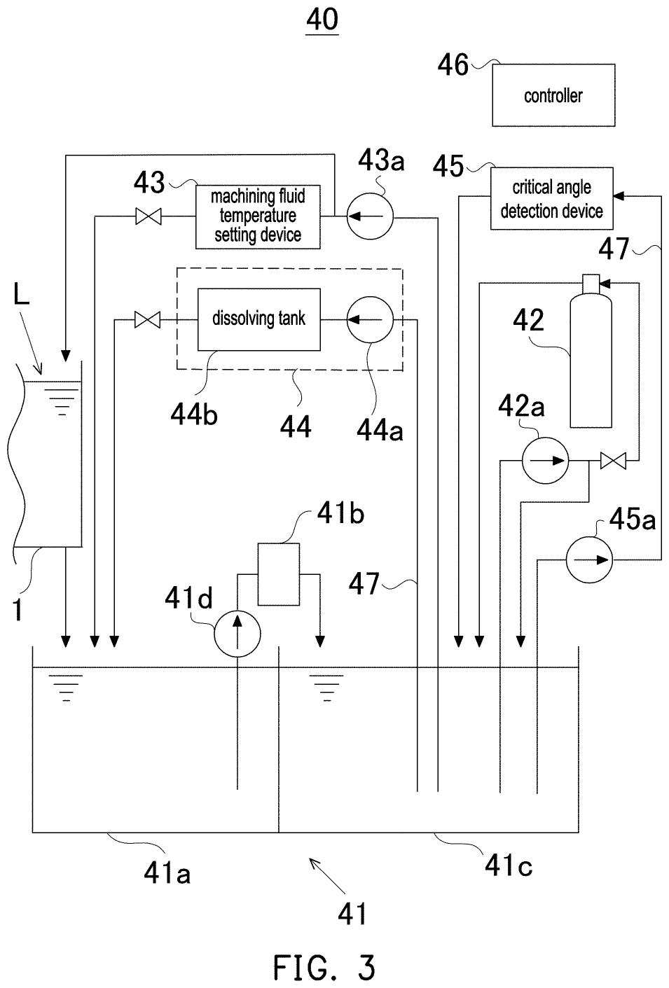

FIG. 2 is a rear side perspective view showing an appearance of the machining fluid supply device 40 according to the embodiment, and FIG. 3 is a system diagram showing a device configuration of the machining fluid supply device 40 according to the embodiment. The machining fluid supply device 40 is a device that continuously circulates and supplies the machining fluid L in which a corrosion inhibitor 44g is added to the machining tank 1. The machining fluid supply device 40 includes a dirty fluid tank 41a that stores the dirty machining fluid L discharged from the machining tank 1, a filter 41b that clarifies the dirty machining fluid L, a clean fluid tank 41c that stores the machining fluid L clarified via the filter 41b, an ion exchange resin unit 42, a machining fluid temperature setting device 43, an addition device 44 that adds the corrosion inhibitor 44g, a critical angle detection device 45 for the machining fluid L, a controller 46 that controls the entire machining fluid supply device 40, and a pipeline 47 for circulating the machining fluid L. Here, the dirty fluid tank 41a and the clean fluid tank 41c are collectively referred to as a machining fluid supply tank 41.

The machining fluid L contaminated by performing the electrical discharge machining while submerging the workpiece W is discharged from the machining tank 1 of the machine body 10 to the dirty fluid tank 41a of the machining fluid supply device 40, and is stored in the dirty fluid tank 41a. The machining fluid L stored in the dirty fluid tank 41a is clarified via the filter 41b by actuating a pump 41d, and is stored in the clean fluid tank 41c. The machining fluid L in the machining fluid supply tank 41 is circulated and supplied to the ion exchange resin unit 42 and the machining fluid temperature setting device 43 by actuating pumps 42a and 43a, and the pH value, the temperature, and the specific resistance value of the machining fluid L are set to predetermined values. Furthermore, a critical angle θ of the machining fluid L is detected by the critical angle detection device 45, and the concentration of the corrosion inhibitor 44g in the machining fluid L is calculated from the critical angle θ. If necessary, the corrosion inhibitor 44g is added to the machining fluid L by the addition device 44.

The ion exchange resin unit 42 is a device that has an ion exchange resin inside, performs an ion exchange of the supplied machining fluid L, and impart an insulation property required as a machining medium for discharge machining to the machining fluid L by adjusting the machining fluid L to a predetermined specific resistance value. By actuating the pump 42a, the machining fluid L in the clean fluid tank 41c is supplied to the ion exchange resin unit 42 from the inside of the pipeline 47, and the ion-exchanged machining fluid L is returned to the clean fluid tank 41c again.

The machining fluid temperature setting device 43 is a device that adjusts the temperature of the machining fluid L to a predetermined value. The machining fluid temperature setting device 43 includes, for example, at least one of a heater and a cooler. The machining fluid L in the clean fluid tank 41c is supplied to the machining fluid temperature setting device 43 by actuating the pump 43a, the temperature of the machining fluid L is raised or lowered by the machining fluid temperature setting device 43, and the machining fluid L whose temperature is adjusted is discharged to the dirty fluid tank 41a. In this way, the machining fluid L in the machining fluid supply tank 41 is circulated while being adjusted in temperature.

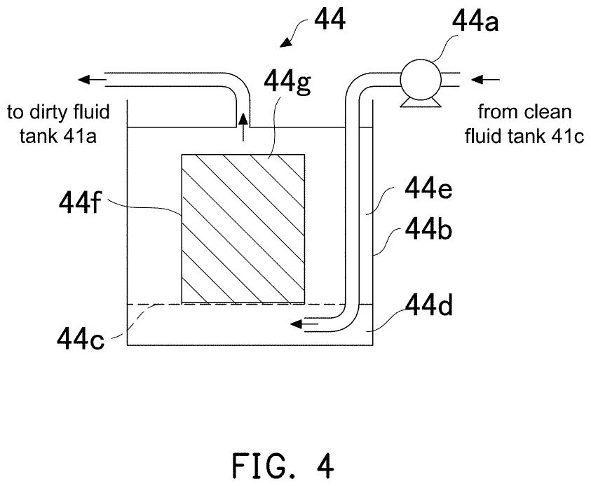

FIG. 4 is a schematic view showing a configuration of the addition device 44 according to the embodiment. The addition device 44 is a device that has the corrosion inhibitor 44g inside, adds a predetermined amount of the corrosion inhibitor 44g to the machining fluid L in the clean fluid tank 41c, and circulates and supplies the machining fluid L to the dirty fluid tank 41a. The addition device 44 includes a pump 44a and a dissolving tank 44b. The dissolving tank 44b accommodates the corrosion inhibitor 44g. The dissolving tank 44b is partitioned by a net-like partition 44c into a machining fluid inflow section 44d formed on the lower side and a dissolving section 44e formed from the intermediate part to the upper side. The machining fluid L sent from the clean fluid tank 41c by the pump 44a is supplied to the dissolving section 44e via the machining fluid inflow section 44d. The powdered corrosion inhibitor 44g packaged in a water-permeable packaging material 44f such as a non-woven fabric is provided in the dissolving section 44e. In the dissolving section 44e, the corrosion inhibitor 44g is dissolved and added to the machining fluid L. The concentration of the corrosion inhibitor 44g in the machining fluid L can be adjusted by setting the discharge amount of the pump 44a properly. As the corrosion inhibitor 44g, for example, powdered adenine (also known as 6-aminopurine, CAS Registry Number 73-24-5) may be used.

The critical angle detection device 45 is a device that detects the critical angle θ of the machining fluid L. The machining fluid L in the clean fluid tank 41c is supplied to a measurement space 452 of the critical angle detection device 45 by actuating a pump 45a. The critical angle detection device 45 measures the critical angle θ of the machining fluid L flowing in the measurement space 452, and discharges the machining fluid L into the clean fluid tank 41c again.

The controller 46 is a device that controls the entire machining fluid supply device 40. The controller 46 includes an input section 461, a storage section 462, a processing section 463, and a display section 464. The input section 461 includes, for example, input interfaces such as a keyboard, a mouse, or a touch panel. The operator inputs operations and information required for various processes in the processing section 463 via the input section 461. The operator can change a time interval for measuring the concentration of the corrosion inhibitor 44g via the input section 461. The display section 464 is an output interface such as a monitor, and displays the information required for various processes.

The storage section 462 is configured by, for example, a storage medium such as a hard disk or a CD-ROM. The storage section 462 stores programs and data required when the machining fluid L collected from the machine body 10 is continuously circulated and supplied to the machining tank 1.

The processing section 463 includes, for example, an arithmetic processing device such as a CPU. The processing section 463 drives the pumps 41d, 42a, 43a, 44a, and 45a, and controls the ion exchange resin unit 42, the machining fluid temperature setting device 43, the addition device 44, and the critical angle detection device 45, based on the programs and data stored in the storage section 462. For example, the processing section 463 drives the critical angle detection device 45 at predetermined time intervals to measure the critical angle θ of the machining fluid L. Then, when the concentration of the corrosion inhibitor 44g calculated from the critical angle θ is lower than the predetermined value optionally set, the processing section 463 drives the addition device 44 to add the corrosion inhibitor 44g to the machining fluid L.

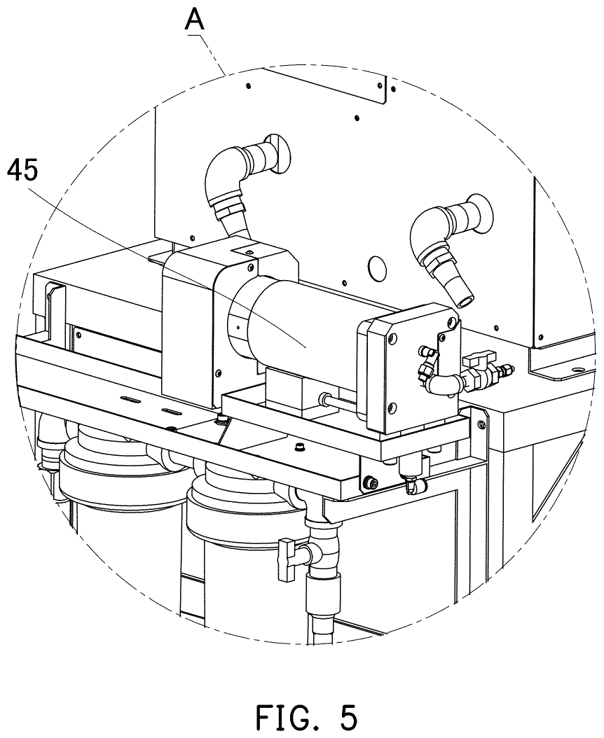

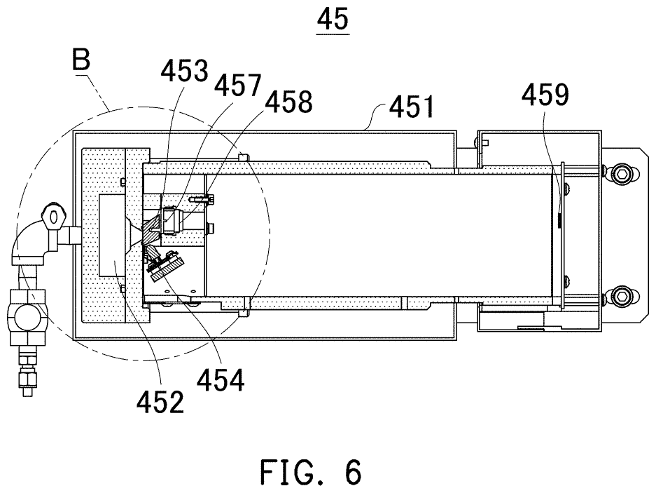

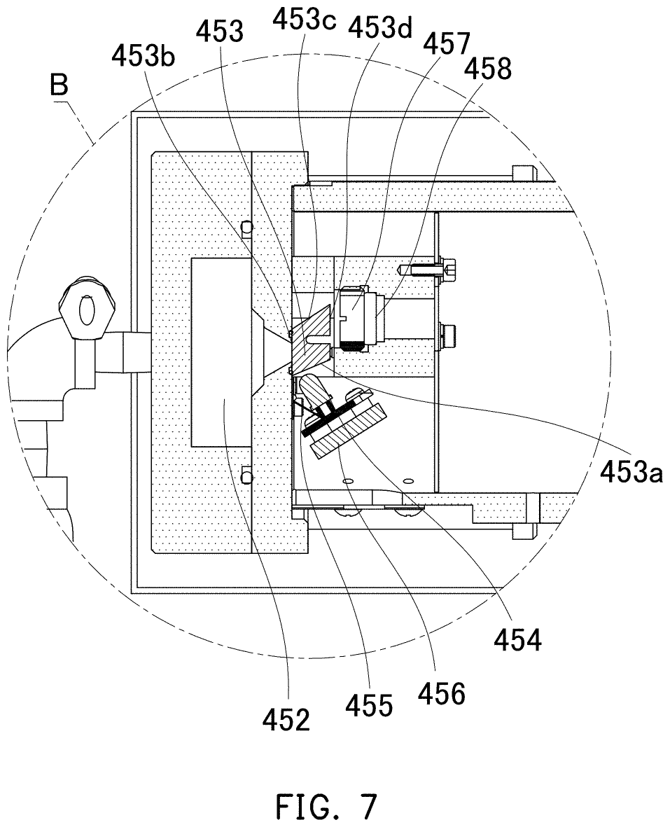

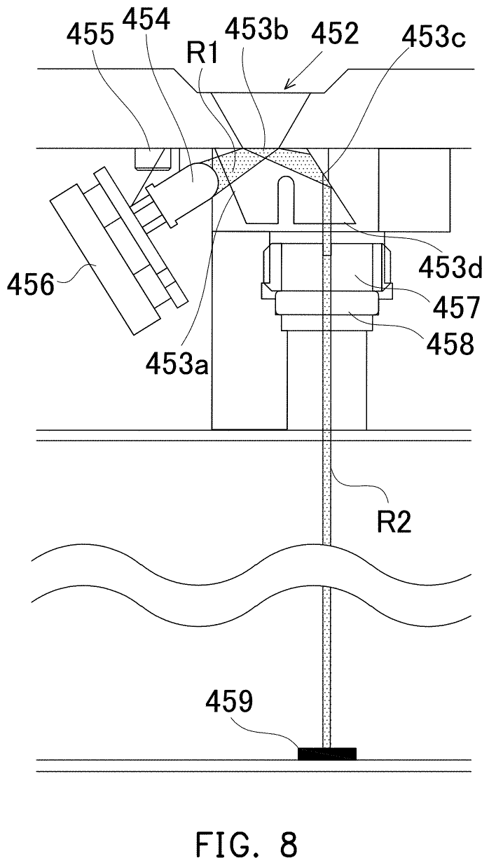

FIG. 5 is an enlarged view of A shown in FIG. 2, and FIG. 6 is a schematic view showing an internal configuration of the critical angle detection device 45 according to the embodiment. FIG. 7 is an enlarged view of B shown in FIG. 6, and FIG. 8 is an illustration view for illustrating an incident light R1 and a reflection light R2 of the critical angle detection device 45 according to the embodiment. The critical angle detection device 45 is a device that measures the critical angle θ of the machining fluid L, using a critical angle method used by a refractive index meter or the like. The critical angle θ at a boundary surface 453b, which is a boundary between the machining fluid L and a prism 453, depends on the concentration of the corrosion inhibitor 44g in the machining fluid L. The critical angle detection device 45 detects the critical angle θ by an image sensor 459 reading the boundary of the critical angle θ indicated by brightness and darkness of the light amount, that is, the position of the critical angle θ.

The critical angle detection device 45 includes a housing 451, the measurement space 452 arranged inside the housing 451, the prism 453, a light source 454, a temperature detector 455, an electrical circuit 456, a lens 457, a slit 458, and the image sensor 459. The incident light R1 is irradiated from the light source 454, which is arranged on the side of an incident surface 453a of the prism 453, to the boundary surface 453b which is the boundary between the prism 453 and the machining fluid L flowing into the measurement space 452. The reflection light R2 reflected by the boundary surface 453b is further reflected by a reflection surface 453c of the prism 453. The image sensor 459 receives the reflection light R2 reflected by the reflection surface 453c via the lens 457 and the slit 458.

The measurement space 452 is a region for temporarily allowing the machining fluid L in the clean fluid tank 41c to flow in. An inflow port and an outflow port of the measurement space 452 are connected to the pipeline 47. The machining fluid L in the clean fluid tank 41c flows into the measurement space 452 from the inflow port via the pipeline 47 by actuating the pump 45a. Then, the critical angle θ of the machining fluid L flowing inside the measurement space 452 is measured. The machining fluid L for which the critical angle θ has been measured flows through the inside of the measurement space 452, is discharged from the outflow port, and returns to the inside of the clean fluid tank 41c.

The prism 453 has the incident surface 453a to which the incident light R1 from the light source 454 is irradiated, the boundary surface 453b which is the boundary between the machining fluid L and the prism 453, the reflection surface 453c, and an emission surface 453d emitting the reflection light R2. The incident surface 453a may be subjected to frosted glass machining to prevent diffused reflection.

The light source 454 is a light emitting body such as an LED arranged on the side of the incident surface 453a of the prism 453.

The temperature detector 455 is a temperature sensor that detects the temperature of the machining fluid L at the time of the critical angle measurement, and for example, a temperature measurement resistor is used. Because the refractive index depends on the temperature, a relationship between the concentration of the corrosion inhibitor 44g in the machining fluid L and the critical angle θ also changes depending on the temperature. Therefore, the temperature of the machining fluid L can be detected by arranging the temperature detector 455 in close proximity to the measurement space 452, and an accurate concentration can be calculated by using the detection value of the temperature detector 455 to correct the concentration.

The lens 457 is a convex lens that forms an image of the reflection light R2 emitted from the prism 453 on the image sensor 459.

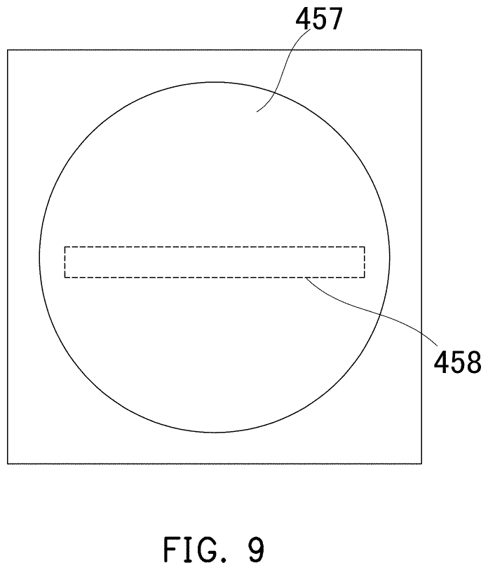

FIG. 9 is a schematic view showing the slit 458 of the critical angle detection device 45 according to the embodiment. The slit 458 is a member that prevents the incidence of a scattered light on the image sensor 459, and an elongated through hole is formed in the slit 458. The slit 458 is arranged on an optical axis of the reflection light R2 between the prism 453 and the image sensor 459 on an emission surface side of the lens 457.

The image sensor 459 is a light receiving sensor that receives the reflection light R2 reflected by the boundary surface 453b which is the boundary between the machining fluid L and the prism 453. As the image sensor 459, a line sensor may be used in which a plurality of photodetectors c1, c2, . . . , cn, . . . , cN are linearly arranged. Additionally, the photodetector cn is the n-th photodetector to be read out, and n is an integer less than or equal to N, which is the number of the photodetectors. The image sensor 459 is arranged in a manner that the reflection light R2 emitted from the prism 453 is vertically incident, and is also arranged in a manner that the horizontal position of the through hole of the slit 458 coincides with the horizontal position of the image sensor 459.

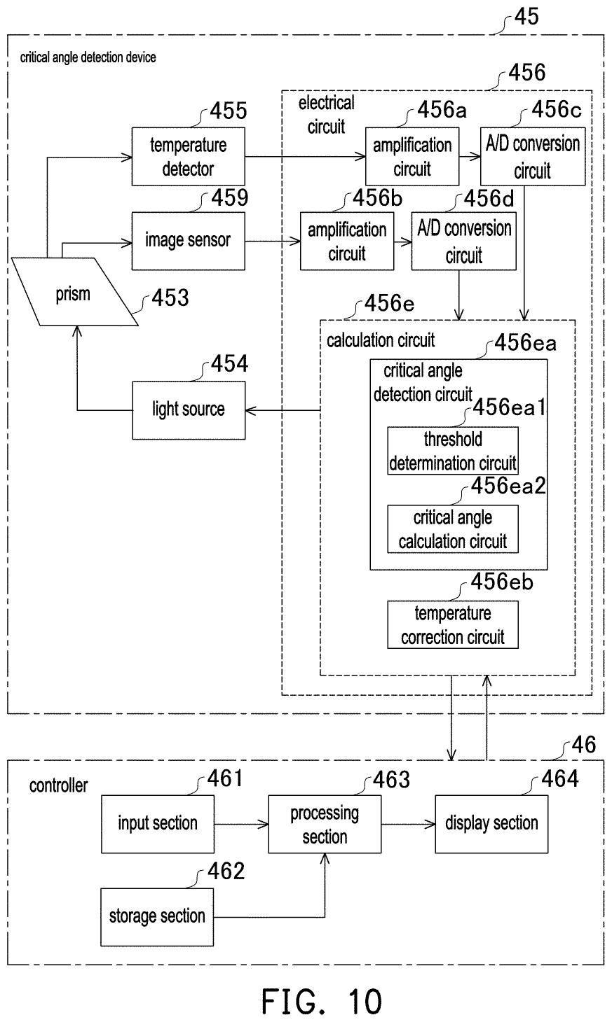

FIG. 10 is a block diagram showing a configuration of the machining fluid supply device 40 according to the embodiment. An electrical circuit 456 is a circuit that arithmetically processes the output from the image sensor 459 and the temperature detector 455. The electrical circuit 456 includes an amplification circuit 456a connected to the temperature detector 455, an A/D conversion circuit 456c connected to the amplification circuit 456a, an amplification circuit 456b connected to the image sensor 459, an A/D conversion circuit 456d connected to the amplification circuit 456b, and a calculation circuit 456e connected to the A/D conversion circuits 456c and 456d.

The amplification circuit 456a is a circuit that amplifies an output signal of the temperature detected by the temperature detector 455. The amplification circuit 456b is a circuit that amplifies an output signal output from the image sensor 459. The amplification circuit 456a and the amplification circuit 456b may include an operational amplifier that differentially amplifies the output signal.

The A/D conversion circuit 456c converts the output signal of temperature output by the amplification circuit 456a into a digital signal. The A/D conversion circuit 456d converts an output voltage, which is the output signal of each photodetector output by the amplification circuit 456b, into a digital signal.

The calculation circuit 456e includes a critical angle detection circuit 456ea and a temperature correction circuit 456eb. The critical angle detection circuit 456ea detects the position of the critical angle θ from digital signals Vc1, Vc2, . . . , Vcn, . . . , VcN of the output voltages output from the A/D conversion circuit 456d. The digital signals Vc1, Vc2, . . . , Vcn, . . . ,

VcN are respectively output signals of the photodetectors c1, c2, . . . , cn, . . . , cN, which are amplified and converted via the amplification circuit 456b and the A/D conversion circuit 456d. The temperature correction circuit 456eb converts the digital signal of temperature output from the A/D conversion circuit 456c into a temperature correction value.

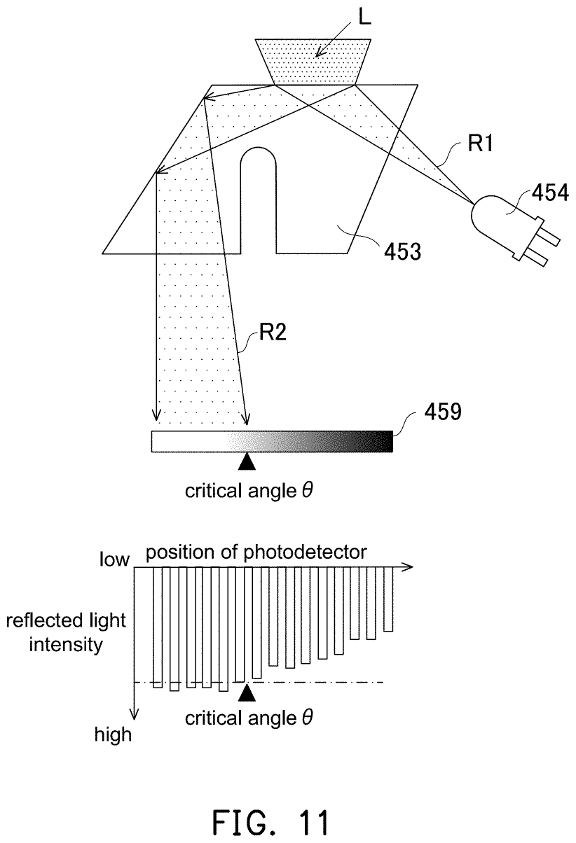

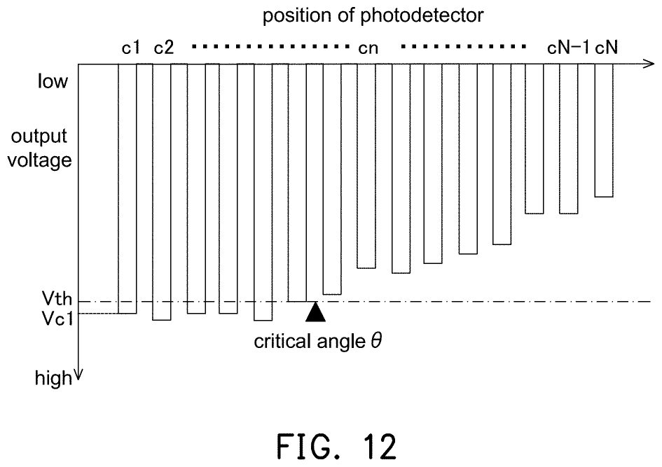

FIG. 11 is an illustration diagram showing a critical angle detection process of the critical angle detection circuit 456ea according to the embodiment, and FIG. 12 is a graph showing a relationship between the positions of the photodetectors of the image sensor 459 and the output voltages of the respective photodetectors. Here, an outline of the critical angle detection process performed by the critical angle detection circuit 456ea is described.

The critical angle detection process of the disclosure is a process utilizing a principle in which because the refractive index of a liquid changes depending on the content of soluble substances, a difference in the refractive index is converted into the concentration and the concentration of the corrosion inhibitor 44g in the machining fluid L is measured. Specifically, in the critical angle detection process of the disclosure, the refractive index of the machining fluid L is calculated from the critical angle θ at the boundary surface 453b, which is the boundary between the machining fluid L and the prism 453 whose refractive index is known. The incident light R1 incident toward the prism 453 is refracted at the critical angle θ at the boundary surface 453b and becomes the reflection light R2. Then, the reflection light R2 undergoes reflection at the reflection surface 453c and generates a brightness/darkness boundary line in the direction of emission from the prism 453. The position of the critical angle θ, which is the brightness/darkness boundary line, is calculated by the calculation circuit 456e from the digital signal detected by the image sensor 459.

The critical angle detection circuit 456ea includes a threshold determination circuit 456ea1 and a critical angle calculation circuit 456ea2. As shown in FIG. 12, the magnitude of the digital signal of the image sensor 459 converted in the A/D conversion circuit 456d is different for each photodetector. In order to determine the position of the critical angle θ which is the brightness/darkness boundary line, first, the photodetectors are divided into photodetectors having a digital signal equal to or higher than a threshold value Vth and photodetectors having a digital signal smaller than the threshold value Vth. Then, the number of the photodetectors having the digital signal smaller than the threshold value Vth is counted, and thereby the position of the critical angle θ is calculated. Because the critical angle θ depends on the concentration of the corrosion inhibitor 44g in the machining fluid L, the concentration of the corrosion inhibitor 44g in the machining fluid L can be calculated from the calculated position of the critical angle θ.

The threshold determination circuit 456ea1 calculates the threshold value Vth. The threshold value Vth may be calculated by adding a constant Cth to a value of the digital signal Vc1 of the first photodetector el that is read out first. In addition, the threshold value Vth may be calculated by reading out the plurality of photodetectors including the first photodetector c1 that is read out first and adding the constant Cth to an average value of the digital signals. More specifically, the threshold value Vth may be calculated by adding the constant Cth to an average value of the digital signals Vc1, Vc2, . . . , Vcn from the first photodetector cl read out first to the n-th photodetector cn read out at the n-th time. For example, the constant Cth is added to an average value of the digital signals Vc1, Vc2, and Vc3 of the first photodetector c1, the second photodetector c2, and the third photodetector c3, and the threshold value Vth is calculated. In this way, a more appropriate threshold value Vth can be calculated. The threshold determination circuit 456ea1 determines a threshold value each time the output signals are read out once from the image sensor 459, specifically, each time the output signals are read out from the photodetectors c1, c2, . . . , cn, . . . , cN. That is, assuming the operation of reading out from the all photodetectors c1, c2, . . . , cn, . . . , cN of the image sensor 459 is one reading operation, the threshold value is determined for each reading operation.

The critical angle calculation circuit 456ea2 calculates the position of the critical angle θ by counting the number of the photodetectors having the digital signals smaller than the threshold value Vth.

In the embodiment, in the calculation circuit 456e, the number of the photodetectors having a digital signal smaller than the threshold value Vth is calculated using the threshold value Vth, but the disclosure is not limited thereto. For example, the position of the critical angle θ may also be calculated based on the number of the photodetectors having a digital signal equal to or higher than the threshold value Vth. Alternatively, for example, the position of the critical angle θ may be calculated using multivariate analysis such as discriminant analysis in the critical angle calculation circuit 456ea2 without arranging the threshold determination circuit 456ea1.

In addition, it is desirable that the concentration be corrected according to the temperature of the machining fluid L because the critical angle θ depends on the temperature of the machining fluid L. In the embodiment, the temperature detected by the temperature detector 455 and the critical angle θ calculated by the critical angle detection circuit 456ea are input to the temperature correction circuit 456eb, and the temperature correction is performed.

The critical angle θ of the machining fluid L after the temperature correction is sent to the controller 46. The controller 46 calculates the concentration of the corrosion inhibitor 44g in the machining fluid L from the critical angle θ and displays the concentration on the display section 464, and when the concentration of the corrosion inhibitor 44g is smaller than the predetermined value, the controller 46 drives the addition device 44 to add the corrosion inhibitor 44g.

In this way, the threshold Vth for determining the position of the critical angle θ is changed for each readout, and the temperature detector 455 is arranged and the concentration of the corrosion inhibitor 44g is corrected according to the temperature of the machining fluid L, and thereby deviations of the concentration value due to changes in the external environment are absorbed, making it possible to more accurately detect the concentration of the corrosion inhibitor 44g in the machining fluid L.

In the electrical discharge machine 100 of the embodiment described above, the critical angle detection device 45 that detects the critical angle θ of the machining fluid L is arranged, and the slit 458 is installed inside the critical angle detection device 45. Thereby, the scattered light is appropriately removed during the measurement. In addition, the electrical discharge machine 100 of the embodiment is configured to change the threshold value Vth for determining the critical angle θ for each readout. Thereby, the deviations of the concentration value due to the changes in the external environment are absorbed. In this way, the electrical discharge machine 100 can more accurately and quickly detect the concentration of the corrosion inhibitor 44g in the machining fluid L, and the concentration of the corrosion inhibitor 44g can be appropriately managed within a specified range even when the measurement light is reduced by external factors such as a temperature change of the machining fluid L. In addition, because the electrical discharge machine 100 of the embodiment includes the addition device 44 which adds the corrosion inhibitor 44g, unattended concentration management of the corrosion inhibitor 44g can be performed.

In the embodiment, the concentration of the corrosion inhibitor 44g in the machining fluid L is calculated from the critical angle θ by the controller 46, but it is also available that the critical angle θ is transmitted to a numerical controller that controls the entire electrical discharge machine 100, and the concentration is calculated by the numerical controller. In other words, the numerical controller may be used as a controller that performs the concentration calculation of the corrosion inhibitor 44g and the like. In addition, in the embodiment, the temperature correction of the critical angle θ is performed by the temperature correction circuit 456eb, but the temperature correction circuit 456eb may not be arranged. In this case, the critical angle θ before the temperature correction and the temperature detected by the temperature detector 455 may be transmitted to the controller 46 or the numerical controller, and thereby the temperature correction and the concentration calculation may be performed by the controller 46 or the numerical controller.

What is claimed is:

1. An electrical discharge machine, comprising a critical angle detection device that detects a critical angle of a machining fluid in which a corrosion inhibitor is added, wherein
the critical angle detection device comprises:
a prism having an incident surface, a boundary surface, a reflection surface, and an emission surface;
a light source that irradiates an incident light from the incident surface to the boundary surface which is a boundary between the prism and the machining fluid;
an image sensor comprising a plurality of photodetectors that detect a reflection light reflected from the boundary surface and the reflection surface;
an electrical circuit that calculates the critical angle by arithmetically processing output signals output from the plurality of photodetectors; and
a slit that is arranged on an optical axis of the reflection light between the prism and the image sensor to block a scattered light.

2. The electrical discharge machine according to claim 1, wherein the electrical circuit comprises:
a threshold determination circuit that determines a threshold value each time the output signals are read out from the image sensor, and
a critical angle calculation circuit that counts the number of the photodetectors having the output signals smaller than the threshold value to calculate the critical angle.

3. The electrical discharge machine according to claim 2, wherein the threshold determination circuit adds a constant to a value of the output signal of a first photodetector among the plurality of photodetectors which is read out first to obtain the threshold value.

4. The electrical discharge machine according to claim 2, wherein the threshold determination circuit adds a constant to an average value of the output signals from a first photodetector among the plurality of photodetectors which is read out first to a n-th photodetector among the plurality of photodetectors which is read out at the n-th time, to obtain the threshold value.

5. The electrical discharge machine according to claim 1, wherein the electrical circuit comprises a critical angle calculation circuit that calculates the critical angle by multivariate analysis of the output signals read out from the plurality of photodetectors.

6. The electrical discharge machine according to claim 2, wherein the critical angle detection device further comprises a temperature detector that detects a temperature of the machining fluid, and
the electrical circuit further comprises a temperature correction circuit that performs concentration correction of the corrosion inhibitor according to the temperature detected by the temperature detector.

7. The electrical discharge machine according to claim 1, wherein the electrical discharge machine further comprises an addition device that accommodates the corrosion inhibitor added to the machining fluid, wherein
the addition device adds the corrosion inhibitor to the machining fluid when a concentration of the corrosion inhibitor detected by the critical angle detection device is lower than a predetermined value.

8. The electrical discharge machine according to claim 1, wherein the critical angle detection device detects the critical angle of the machining fluid flowing inside the critical angle detection device.

9. The electrical discharge machine according to claim 1, comprising a machine body and a machining fluid supply device, wherein
the machining fluid supply device has a pipeline for circulating the machining fluid, and
the critical angle detection device is arranged in the pipeline.
